(19) United States
(12) Patent Application Publication
(10) Pub. No.: US 2015/0060227 A1
(43) Pub. Date: Mar. 5, 2015

(54) MATING SURFACE OF A FRICTION PAIRING

(71) Applicant: Schaeffler Technologies GmbH & Co. KG, Herzogenaurach (DE)

(72) Inventor: Stefan Steinmetz, Esslingen (DE)

(73) Assignee: Schaeffler Technologies GmbH & Co., KG, Herzogenaurach (DE)

(21) Appl. No.: 14/390,872

(22) PCT Filed: Mar. 21, 2013
(86) PCT No.: PCT/EP2013/055944

§ 371 Date: Oct. 6, 2014

(30) Foreign Application Priority Data
Apr. 16, 2012 (DE) 102012206130.4

(51) Int. Cl. F16D 69/02

(52) U.S. Cl. CPC F16D 69/027; F16D 69/02
USPC 192/107 M; 192/107 R

(57) ABSTRACT

A mating surface of a friction pairing is provided which includes a friction surface that can be connected and/or is connected to the mating surface in a friction-fit manner in the operation of the friction pairing for torque transmission. The invention is characterized in that the mating surface is provided with a heat dissipation coating which has a significantly higher level of heat conductivity than a carrier material on which the heat dissipation coating is applied.

### BACKGROUND

The invention relates to a mating surface of a friction pairing, which comprises a friction surface that can be connected and/or is connected to the mating surface in a friction-fit manner in the operation of the friction pairing for torque transmission.

A heat curing adhesive is known from the German publication DE 29 23 051 A1 for adhering brake pads comprising graphite. Friction materials with structured surfaces for the use in clutch plate elements, brake pads, transmissions, and the like are known from the translation DE 697 29 939 T2 of the European patent publication EP 0 892 896 B1. The German publication DE 196 26 686 A1 discloses a clutch disk with friction elements which are embodied as so-called pads and are adhered to a carrier.

### SUMMARY

The objective of the invention is to reduce any undesired occurrence of local temperature maxima during the operation of a friction pairing comprising a friction surface which can be connected to a mating surface in a friction-fit manner for torque transmission.

The objective is attained in a mating surface of a friction pairing comprising a friction surface, which can be connected and/or is connected to the mating surface in a friction-fit manner in the operation of the friction pairing for torque transmission, characterized in that the mating surface is provided with a heat dissipation coating, which shows a considerably greater heat conductivity than the carrier material on which the heat dissipation coating is applied. The friction surface is embodied for example at a clutch disk and preferably provided with an organic friction coating. The mating surface is made from metal, for example. By the heat dissipation coating according to the invention, exhibiting a high level of heat conductivity, the surface temperature can be reduced during the generation of the friction-fit connection, because any heat developing during the generation of the friction-fit connection can be dissipated faster. The heat conductivity in the friction-fit contact can be significantly accelerated by the heat dissipation coating. This way the life span of the friction pairing can be extended. The thermal energy developing at the local friction sites can be dissipated as fast as possible via the heat dissipation coating. This way any undesired increase of the surface temperature can be stopped or reduced. Thus, damages of the surface can be avoided and the thermal limits of the system can be considerably expanded. The friction process can be understood as a heat pulse, which is highly dynamic and in case of disadvantageous thermo-technical characteristics of the mating partner can create a hot spot, which in turn leads to undesired high temperatures. According to an essential aspect of the invention the undesired increase in temperatures can be avoided or reduced when the thermal energy is dissipated with the same dynamic by which the thermal energy is introduced using the heat dissipation coating in the areas with high thermal capacity. By the heat dissipation coating with high conductivity the dynamic local heat dissipation to the mating surface can be considerably increased. Furthermore, the heat exchange volume available and/or the heat exchange area available at the side of the friction partner can be increased with the mating surface, increasing the heat dissipation per time unit.

A preferred exemplary embodiment of the mating surface is characterized in that the carrier material is formed from a metallic material. The carrier material is made for example from steel or cast iron. Steel shows a heat conductivity of 48 to 58 Watts per meter per Kelvin, for example. The heat conductivity of the heat dissipation coating according to the invention amounts preferably to a multiple of the heat conductivity of steel. A heat dissipation coating made from aluminum nitride shows a heat conductivity of 180 Watts per meter per Kelvin, for example. A heat dissipation coating made from carbon (graphite) shows a heat conductivity ranging from 119 to 165 Watts per meter per Kelvin. A DLC (diamond-like-carbon)-coating shows a heat conductivity of 1,100 Watts per meter per Kelvin, for example. With carbon nanotubes for example a heat dissipation coating can be produced showing a heat conductivity of 6,000 Watts per meter per Kelvin.

Another preferred exemplary embodiment of the mating surface is characterized in that the heat dissipation coating comprises a nitride layer and/or a carbon-like layer, such as DLC (diamond-like-carbon)-layer. The use of such coatings for the purpose of reducing friction or for protection from wear and tear in the context with bearing elements or gliding elements is known per se. For example, a deflection device for a shifting clutch with a gliding element and an annular flange is known from the German publication DE 10 2004 062 586 A1, which is provided with a DLC-coating. The German publication DE 10 2011 016 996 A1 discloses a clutch arrangement with a cap bearing comprising a bearing body, which is provided with a wear-resistant DLC-coating. Contrary thereto, the heat dissipation coating according to the invention is used for reducing the surface temperature during the friction-fit contact.

Another preferred exemplary embodiment of the mating surface is characterized in that the heat dissipation coating comprises a metallic coating material, which shows a considerably higher level of heat conductivity than the carrier material on which the heat dissipation coating is applied. The metallic coating material shows for example a heat conductivity which is three to six times higher than the heat conductivity of steel.

Another preferred exemplary embodiment of the mating surface is characterized in that the metallic coating material comprises aluminum and/or copper. The aluminum and/or copper are preferably provided in the form of an alloy. Aluminum shows for example a heat conductivity of 236 Watts per meter per Kelvin. Copper for example shows a heat conductivity of 240 to 280 Watts per meter per Kelvin.

Another preferred exemplary embodiment of the mating surface is characterized in that the heat dissipation coating comprises a coating material, which can absorb heat energy by way of phase conversion and can release it with a time delay. Such a coating material can also be called latent heat storage (phase-changed material). When using such a coating material the physical effect is utilized that the temperature remains constant during phase conversion.

Another preferred exemplary embodiment of the mating surface is characterized in that the heat dissipation coating has a thickness of at least 10 micrometers, preferably approximately 20 micrometers. These values have proven particularly advantageous within the scope of the present invention.

Another preferred exemplary embodiment of the mating surface is characterized in that the mating surface is provided with the heat dissipation coating at a mating plate of a wet-operating clutch system of a compression plate, a central plate, and/or a secondary flywheel of a dry-operating clutch system. The heat dissipation coating according to the invention has proven advantageous both in the dry-operating as well as in wet-operating clutch systems.

Another preferred exemplary embodiment of the mating surface is characterized in that the mating surface and/or the heat dissipation coating have an enlarged surface. The enlarged surface increases the heat dissipation area available. The heat dissipation surface can be increased, for example by the morphology of the laminar structure itself. The heat dissipation surface can also be increased by an appropriate pre-treatment, such as sandblasting.

Furthermore, the invention relates to a clutch friction partner with a mating surface as described above.

### BRIEF DESCRIPTION OF THE DRAWINGS

Additional advantages, features, and details of the invention are discernible from the following description, in which various exemplary embodiments are described in greater detail with reference to the drawing. Shown are:

FIG. 1 a Cartesian coordinate diagram in which a friction power curve is shown, and

FIG. 2 a simplified cross-sectional illustration of a mating plate with a heat dissipation coating according to the invention.

### DETAILED DESCRIPTION OF THE PREFERRED EMBODIMENTS

In general, the invention relates to clutches, particularly starting clutches, which may be embodied either as dry or as wet-operating clutches. During a clutch process in general the transmission side and an engine side are synchronized in order to allow torque transfer from the motor side, which is also called drive side, to the driven side.

For this purpose, the clutch has two friction partners, which represent a friction pairing. One of the friction partners is equipped with a friction surface, which can be preferably implemented by organic friction coating. The other friction partner is made from a metallic material, for example, and provided with a mating surface, which is connected to the friction surface in a friction-fit manner for torque transmission. For the purpose of torque transmission the friction surface and the mating surface are compressed by compression forces.

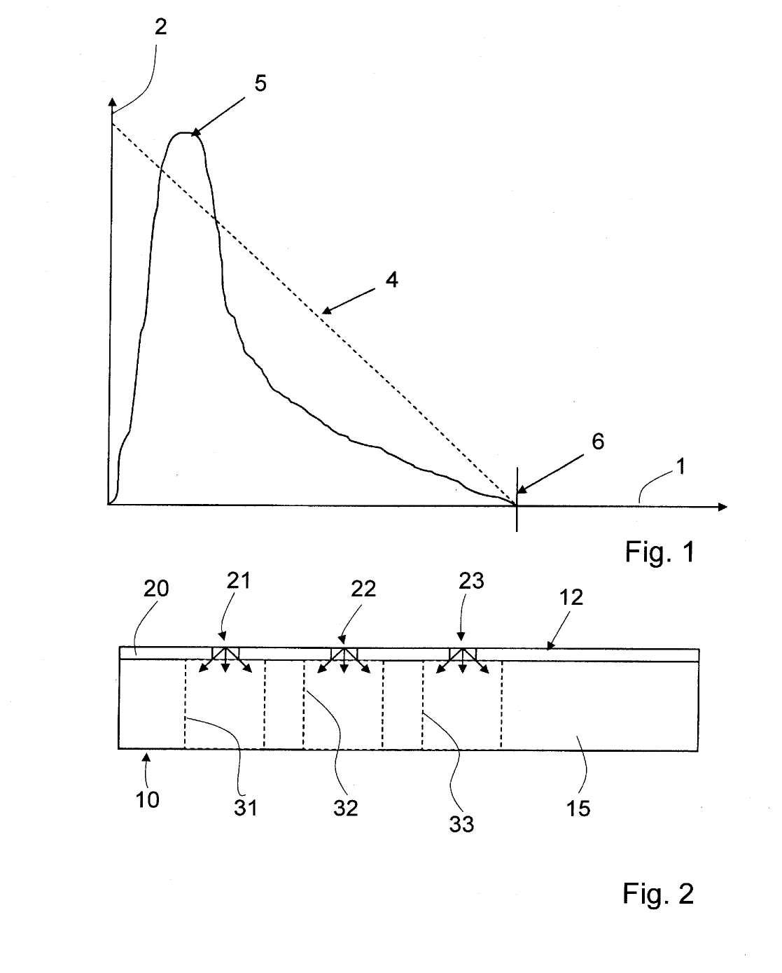

The synchronization of a transmission and a motor speed is physically achieved by a friction process. Depending on the speed and the friction moment, here a friction power curve results over the synchronization process, as shown in FIG. 1.

FIG. 1 shows a Cartesian coordinate diagram of an x-axis 1 and a y-axis 2. Here, the time is marked at the x-axis 1 in a suitable time unit. A speed in rotations per minute is marked at the y-axis 2. The progression of a rotational speed difference between the transmission side and the motor side is indicated by a dot-dash line 4. Furthermore, a friction power is marked on the y-axis 2 in a suitable unit. The progression of the friction power over time is shown in a curve 5.

The rotational speed difference 4 drops from a maximum value at the beginning of the synchronization process to zero at the end of said synchronization process. A line 6 indicates the point of time at which the synchronization is completed. At the point of time 6 the motor speed is equivalent to the transmission speed, this means the rotational speed difference is zero.

At the beginning of the synchronization, thus at maximum rotational speed difference, the friction power quickly reaches a maximum as well. The friction power is largely converted into heat and, depending on the thermal behavior of the friction partners, it is dissipated by them.

In addition to the friction surface available and/or the direct, actual contact surface between the friction surface and the mating surface, the dynamic of this heat dissipation and/or the thermal-physical data of the friction partners determine, the surface temperature, which can be reached during the shifting process. The capacity of a friction system is essentially limited by the temperature in the friction contact, which is depending on the load applied.

In conventional friction systems the material of the friction coating represents the limiting component both in dry operating as well as wet-operating systems. High surface temperature caused by high friction power in dry operating systems may for example lead to the thermal disintegration of a binder, which may be component of the friction coatings. Such thermal disintegration of the binder can lead to a spontaneous drop of the friction coefficient.

In wet-operating systems, among other things, high friction power leads to so-called glazing of a wet-operating coating. This irreversibly worsens the comfort features, particularly the friction features, of the wet-operating coating. In the extreme case, high friction power can lead to a disproportional increase of the wear and tear and thus to a reduction of the depth of cooling grooves. This in turn can lead to a complete destruction of the coating and thus to system failure.

A fundamental concept of the invention is to dissipate heat energy as quickly as possible, which develops at local friction areas. This way, any excessive, damaging increase of the surface temperature will be reduced. For example, here the thermal limits of the system can be considerably expanded.

Within the scope of the present invention the friction process is understood as a thermal pulse, which is highly dynamic and in case of disadvantageous thermo-technical characteristics of the friction partners causes a hot spot, which in turn generates high temperatures. The increase in temperature is avoided or reduced according to an essential aspect of the invention due to the thermal energy being dissipated into areas with high thermal capacity with the same dynamic as the one introducing the thermal energy.

FIG. 2 shows in a simplified cross-section a counter plate 10 with a counter surface 12. The counter plate 10 comprises a metallic carrier material 15. According to an essential aspect of the invention, a heat dissipation coating 20 is applied on the metallic carrier material 15. The heat dissipation coating 20 has a thickness of twenty micrometers.

The arrows indicate local friction areas 21, 22, 23 with high heat input. In order to dissipate the heat to the local friction areas 21 to 23, the heat dissipation coating 20 exhibits very high heat conductivity. The heat conductivity is a thermal parameter which influences the dynamic of the heat dissipation.

The heat capacity of a material describes the quantity of heat that can be stored in a material. The higher this capacity the lower the temperature increase connected with heat introduced therein, compared to similar masses. The following table shows the heat conductivity lambda in Watts per meter per Kelvin and the heat capacity in Joule per kilogram per Kelvin at twenty degrees Centigrade.

| | | | | |
|---|---|---|---|---|
| Steel | λ = 48-58 | W/m*K | 460-540 | J/kg*K |
| Carbon (graphite) | λ = 119-165 | W/m*K | 715 | J/kg*K |
| Carbon nanotubes | λ = 6,000 | | | |
| Aluminum nitride | λ = 180 | W/m*K | 700-760 | J/kg*K |
| DLC-coating | λ = 1,100 | W/m*K | 500 | J/kg*K |

By increasing the local dynamic heat dissipation, here so-called hotspots are reduced. This way the friction materials can be protected from excessively high temperatures. In case of wet-operating applications the heat dissipation coating 20 can keep the thickness of the oil film constant due to better heat dissipation. This way a constant friction behavior can be achieved.

The higher local dynamic heat dissipation is realized by the heat dissipation coating 20. The heat dissipation coating 20 shows a considerably higher heat conductivity than steel or cast iron. Coatings from the families of nitride and carbon-like coatings, such as DLC-coatings, may be considered for the heat dissipation coating 20.

The letters DLC represent diamond-like-carbon. According to an essential aspect of the invention the coatings known from other applications are used in a targeted fashion in order to increase the heat conductivity to the counter surface 12 and to reduce the surface temperatures during friction contact.

The heat dissipation coating 20 can also be embodied as a metallic coating. Preferably aluminum or copper and/or their alloys are used for metallic coatings.

In FIG. 2, rectangles 31, 32, 33 are indicated by dot-dash lines, which are arranged in the carrier material 15 underneath the heat dissipation coating 20. The rectangles 31 to 33 indicate that larger volume elements with higher heat capacity compared to the local friction areas 21 to 23 can be shown by the heat dissipation coating 20 according to the invention. In the embodiment shown, the carrier material 15 represents steel. Alternatively the carrier material 15 may also be a cast material.

### LIST OF REFERENCE CHARACTERS

1 x-axis
2 y-axis
4 dot-dash line
5 curve
6 line
10 counter plate
12 counter surface
15 carrier material
20 heat dissipation coating
21 local friction area
22 local friction area
23 local friction area
31 rectangle
32 rectangle
33 rectangle

1. A counter surface of a friction pairing comprising a friction surface, which during operation of the friction pairing is connectable or is connected to a counter surface in a friction-fit manner for torque transmission, the counter surface comprises a heat dissipation coating, which exhibits a considerably higher heat conductivity than a carrier material on which the heat dissipation coating is applied.

2. A counter surface according to claim 1, wherein the carrier material is formed from a metallic material.

3. A counter surface according to claim 1, wherein the heat dissipation coating comprises at least one of a nitride layer or a carbon-like layer.

4. A counter surface according to claim 1, wherein the heat dissipation coating comprises a metallic coating material.

5. A counter surface according to claim 4, wherein the metallic coating material includes at least one of aluminum or copper.

6. A counter surface according to claim 1, wherein the heat dissipation coating comprises a coating material, which can absorb thermal energy by way of phase conversion and then release the absorbed energy in a time-delayed fashion.

7. A counter surface according to claim 1, wherein the heat dissipation coating exhibits a thickness of at least 10 micrometers.

8. A counter surface according to claim 1, wherein the counter surface with the heat dissipation coating is provided at a counter plate of a wet-operating clutch system or at a compression plate, a central plate, or a secondary flywheel of a dry-operating clutch system.

9. A counter surface according to claim 1, wherein the counter surface or the heat dissipation coating have an enlarged surface.

10. A clutch friction partner comprising a counter surface according to claim 1.

11. A counter surface according to claim 3, wherein the carbon-like layer is a DLC (diamond-like carbon) layer.
